(19) United States
(12) Patent Application Publication
(10) Pub. No.: US 2017/0330148 A1
(43) Pub. Date: Nov. 16, 2017

(54) Systems and Methods of Managing a Project

(71) Applicant: Alex Griffith, Brooklyn, NY (US)

(72) Inventor: Alex Griffith, Brooklyn, NY (US)

(21) Appl. No.: 15/592,148

(22) Filed: May 10, 2017

Related U.S. Application Data
(60) Provisional application No. 62/333,854, filed on May 10, 2016.

(51) Int. Cl. G06Q 10/10; G06Q 10/06; G06Q 20/22; G06Q 50/00

(52) U.S. Cl. CPC G06Q 10/101; G06Q 50/01; G06Q 10/063114; G06Q 20/29

(57) ABSTRACT

Disclosed is a method of managing a project of a client, the method comprising: receiving a client-created project which comprises at least one task; and, each of the at least one task comprises an associated cost; displaying the associated costs for each of the at least one task; displaying a graphical user interface of each of the at least one task of the project; obtaining a client-indicated invitation for a crowdsourcing freelancer for each of the at least one task; receiving a crowdsourcing freelancer-submitted proposal; receiving a client-awarded crowdsourcing freelancer job; obtaining a client-proposed request for funding for each of the at least one task; receiving a crowdfunder-provided funds for a crowdfunder specified task; displaying a progression of the crowdfunder-provided funds; obtaining a crowdsourcing freelancer-inputted performance of work for each of the at least one task; and, displaying a progression of performance of work.

### CROSS-REFERENCE TO RELATED APPLICATIONS

The present application claims priority to provisional U.S. patent application Ser. No. 62/333,854, filed May 10, 2016 and entitled “Giggrabbers Project Management Tool,” the disclosure of which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to software that combines the management of a project with crowdsourcing and crowdfunding. Generally, crowdsourcing (online outsourcing of personnel) and crowdfunding (monetary funds) are conducted via the internet. However, crowdfunding lacks transparency and accountability. With regard to the lack of transparency, crowdfunders generally do not know how the recipient will use the money the crowdfunders have invested or pledged. Additionally, crowdfunders cannot track how the recipient uses the money. With regard to accountability, crowdfunders generally do not if their money will be used on a specific task or if other crowdfunders have pledged money for the same tasks. The present invention solves these and other problems, as the crowdfunders have the ability to pick and choose the amount of money and how the money will be used by selecting a specific task. The present invention also provides further transparency by displaying the progress of the funding and the progress of the completion of the work on the project.

### BRIEF SUMMARY OF THE INVENTION

An embodiment of the present invention is a computer system comprising: at least one processor unit; at least one memory unit coupled to the at least one processor unit; and, computer readable instructions embodied in the memory unit and executable by the processor unit, wherein execution of the instructions by the processor unit causes the computing system to perform a method of managing a project of a client, the method comprising: receiving a client-created project, wherein the project comprises at least one task; and, wherein each of the at least one task comprises an associated cost; displaying the associated costs for each of the at least one task; displaying a graphical user interface of each of the at least one task of the project; obtaining a client-indicated invitation for a crowdsourcing freelancer for each of the at least one task; receiving a crowdsourcing freelancer-submitted proposal; receiving a client-awarded crowdsourcing freelancer job; obtaining a client-proposed request for funding for each of the at least one task; receiving a crowdfunder-provided funds for a crowdfunder specified task; displaying a progression of the crowdfunder-provided funds; obtaining a crowdsourcing freelancer-inputted performance of work for each of the at least one task; and, displaying a progression of performance of work.

Another embodiment of the present invention is a method of managing a project of a client, the method comprising: receiving a client-created project, wherein the project comprises at least one task; and, wherein each of the at least one task comprises an associated cost; displaying the associated costs for each of the at least one task; displaying a graphical user interface of each of the at least one task of the project; obtaining a client-indicated invitation for a crowdsourcing freelancer for each of the at least one task; receiving a crowdsourcing freelancer-submitted proposal; receiving a client-awarded crowdsourcing freelancer job; obtaining a client-proposed request for funding for each of the at least one task; receiving a crowdfunder-provided funds for a crowdfunder specified task; displaying a progression of the crowdfunder-provided funds; obtaining a crowdsourcing freelancer-inputted performance of work for each of the at least one task; and, displaying a progression of performance of work.

Yet another embodiment of the present invention is a non-transitory computer readable medium having computer readable instructions embodied therein, the computer readable instructions being configured to implement a method of managing a project of a client when executed, the method comprising: receiving a client-created project, wherein the project comprises at least one task; and, wherein each of the at least one task comprises an associated cost; displaying the associated costs for each of the at least one task; displaying a graphical user interface of each of the at least one task of the project; obtaining a client-indicated invitation for a crowdsourcing freelancer for each of the at least one task; receiving a crowdsourcing freelancer-submitted proposal; receiving a client-awarded crowdsourcing freelancer job; obtaining a client-proposed request for funding for each of the at least one task; receiving a crowdfunder-provided funds for a crowdfunder specified task; displaying a progression of the crowdfunder-provided funds; obtaining a crowdsourcing freelancer-inputted performance of work for each of the at least one task; and, displaying a progression of performance of work.

In another embodiment of the present invention, the crowdfunder funds the at least one task.

In yet another embodiment of the present invention, the crowdfunder funds the project.

In another embodiment of the present invention, the crowdfunder funds a part of the at least one task.

In yet another embodiment of the present invention, the crowdfunder is the client.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a swim-lane diagram of an embodiment of the present invention.

FIG. 2 illustrates a process of managing a project.

FIG. 3 illustrates a computerized system of managing a project.

FIG. 4 is an example of a computing environment that can be utilized by embodiments of the present invention.

FIG. 5 illustrates an example of a computing system that can be configured to perform any of the processes of the present invention described herein.

FIGS. 6-23 illustrate screen shots of a graphical user interface for implementation of embodiments of the present invention.

### DETAILED DESCRIPTION OF THE INVENTION

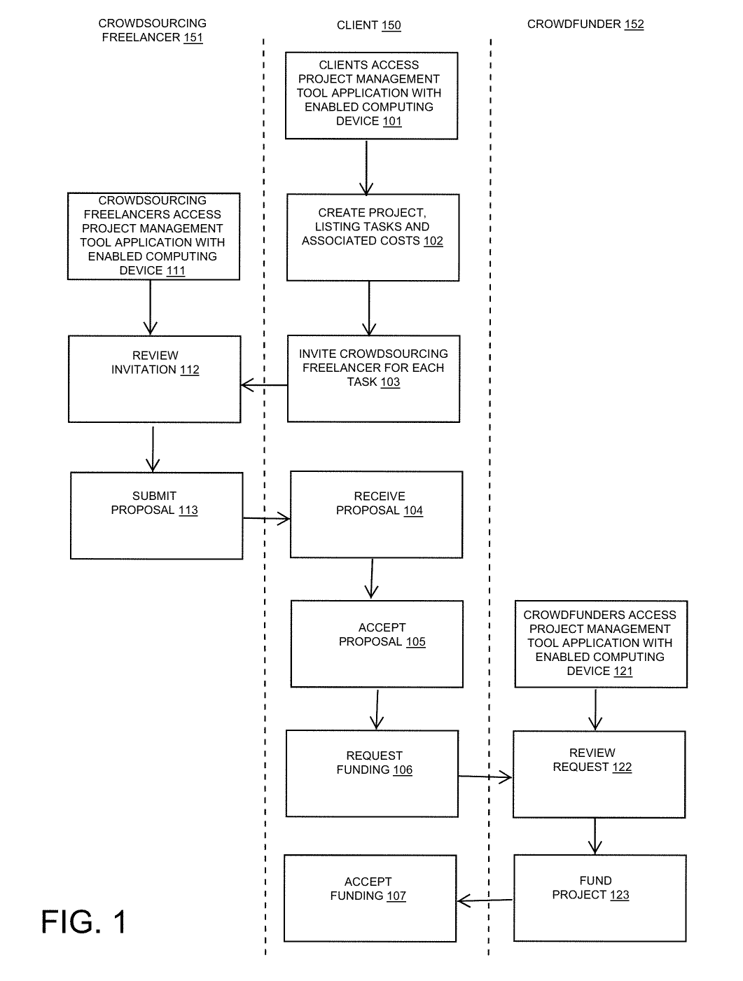

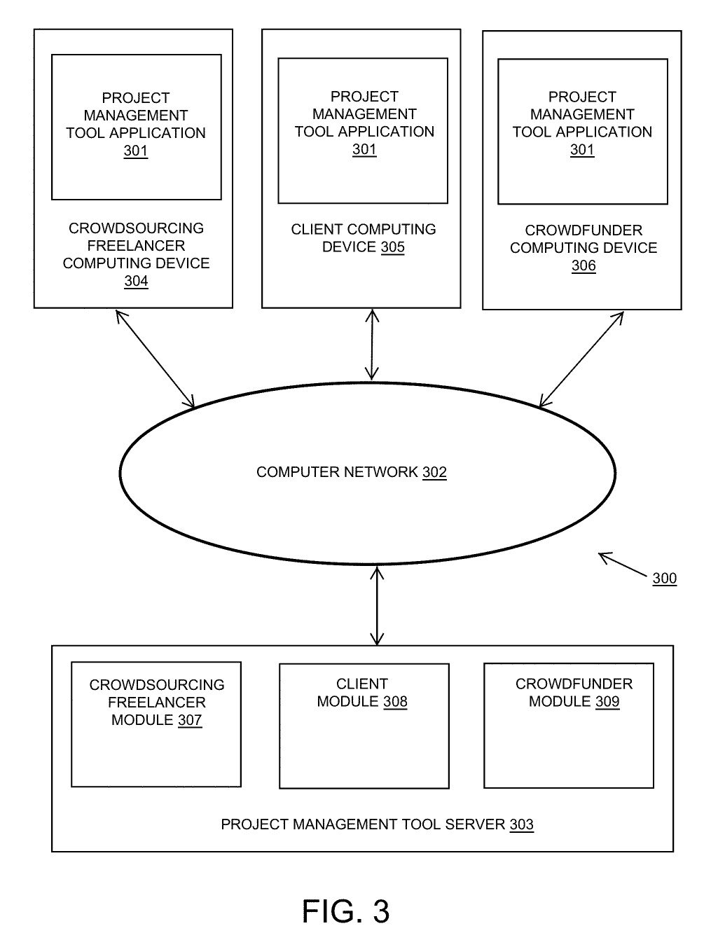

FIGS. 1 and 3 illustrate an embodiment of the present invention. Clients 150 access the project management tool application 301 with an enabled computing device 305 (101). The clients 150 create projects and lists associated tasks and associated costs (102) and then invite crowdsourcing freelancers 151 for each task (103).

Crowdsourcing freelancers 151 access project management tool application 301 with an enabled computing device 304 (111). The crowdsourcing freelancers 151 then review the invitation (112) and submit proposals (113).

Clients 150 then receive the proposals (104), accept proposals (105) of the clients' 150 choice. Thereafter, clients 150 may request funding (106) from crowdfunders 152.

Crowdfunders 152 access project management tool application 301 with an enabled computing device 305 (121). The crowdfunders 152 then review the requests (122) and fund project (123) of the crowdfunders' 152 choice. The clients 150 then accept the funding (107) based upon the condition that the funds will be applied towards the crowdfunders' wishes. A client 150 may only apply funds to the project that crowdfunder 152 chose to fund. In step 123, “projects” refers to whichever part that the crowdfunder 152 chose to fund, for example, the crowdfunder may have chosen to fund the entire project, one task, several tasks, or part of a task. In step 122, the crowdfunders 152 review the requests by examining the overall project, including descriptions, different tasks, costs and other related information.

The enabled computing devices 304, 305, 306 may include such devices as tablet computers, smart phones, personal computers, laptop computers, scanners, game consoles and the like. The project management tool application 301 may be software designed to help the clients manage a project and interact with crowdsourcing freelancers 151 and crowdfunders 152. The project management tool application 301 may also communicate with the project management tool server 303 through the computer network 302. The computer network 302 may be, for example, the internet.

The project management tool server 303 may contain various modules, including crowdsourcing freelancer module 307, the client module 308 and the crowdfunder module 309. Each module 307, 308, 309 may store data. For example, the crowdsourcing freelancer module 307 may store the crowdsourcing freelancer's 151 background (name, location, account number, login name, passwords, specialty, past projects, among other information), and other information. The client module 308 may store information, details, and descriptions of the client's 150 background (name, location, account number, login name, passwords, among other information), project details (type of project, task information, budget, among other information), and other information. Also, the crowdfunder module 309 may store the crowdfunder's 152 background (name, location, account number, login name, passwords, past funded projects, among other information), and other information. The crowdfunder module 309 may also contain a hyperlink to a third-party payer (e.g., PayPal) that allows the crowdfunder 152 to fund a project of the client 150. The project management tool server 303 may contain various other modules not shown, such as, a module that allows the client 150 to generate, create and post videos related the client's 150 project.

“Crowdsource freelancer” may refer to a worker or a group of workers who may perform one or more tasks. The services of crowdsource freelancers may be typically enlisted to via the internet. “Crowdfunding” may be the practice of funding a project or venture by raising monetary contributions from one or more persons. Generally, crowdfunding is executed via the internet. “Crowdfunder” may be those who contribute monetary funds to a project or venture.

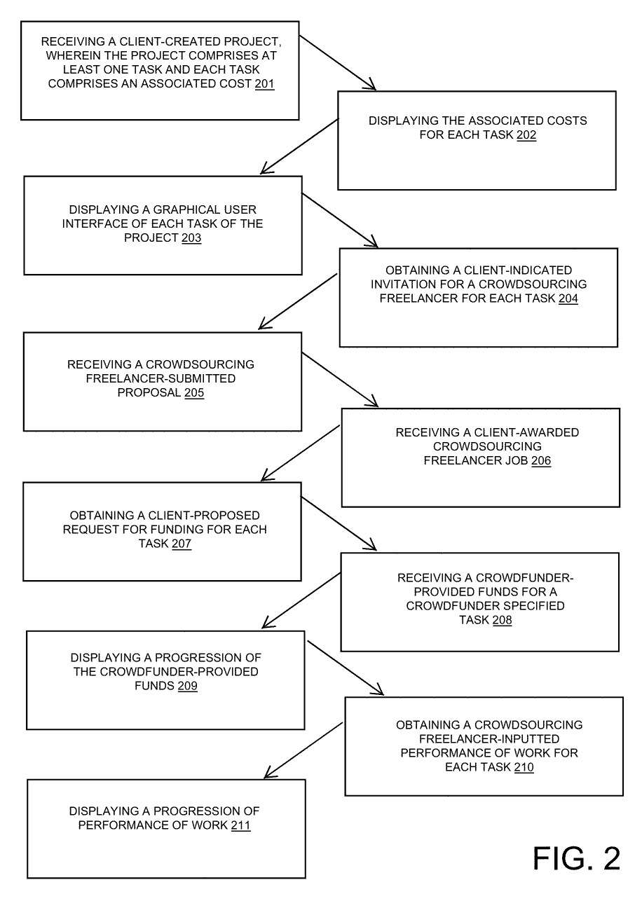

As illustrated in FIG. 2, an embodiment of the present invention is a computer system comprising: at least one processor unit; at least one memory unit coupled to the at least one processor unit; and, computer readable instructions embodied in the memory unit and executable by the processor unit, wherein execution of the instructions by the processor unit causes the computing system to perform a method of managing a project of a client.

The method of managing a project of a client comprises receiving a client-created project, wherein the project comprises at least one task; and, wherein each of the at least one task comprises an associated cost 201; displaying the associated costs for each of the at least one task 202; displaying a graphical user interface of each of the at least one task of the project 203; obtaining a client-indicated invitation for a crowdsourcing freelancer for each of the at least one task 204; receiving a crowdsourcing freelancer-submitted proposal 205; receiving a client-awarded crowdsourcing freelancer job 206; obtaining a client-proposed request for funding for each of the at least one task 207; receiving a crowdfunder-provided funds for a crowdfunder specified task 208; displaying a progression of the crowdfunder-provided funds 209; obtaining a crowdsourcing freelancer-inputted performance of work for each of the at least one task 210; and, displaying a progression of performance of work 211. In step 208, the crowdfunder 152 may fund the entire project, one task, several tasks or part of a task.

A crowdfunder 152 may fund one task, more than one task, part of one task, the entire project, or an amount of the crowdfunder's 152 choice. The client 150 may act as a crowdfunder 125 by funding one task, more than one task, part of one task, the entire project, or an amount of the client's 150 choice.

Another embodiment of the present invention is a non-transitory computer readable medium having computer readable instructions embodied therein, the computer readable instructions being configured to implement a method of managing a project of a client when executed. “Non-transitory computer readable medium” may not include a transitory signal.

The method of managing a project of a client comprises receiving a client-created project, wherein the project comprises at least one task; and, wherein each of the at least one task comprises an associated cost 201; displaying the associated costs for each of the at least one task 202; displaying a graphical user interface of each of the at least one task of the project 203; obtaining a client-indicated invitation for a crowdsourcing freelancer for each of the at least one task 204; receiving a crowdsourcing freelancer-submitted proposal 205; receiving a client-awarded crowdsourcing freelancer job 206; obtaining a client-proposed request for funding for each of the at least one task 207; receiving a crowdfunder-provided funds for a crowdfunder specified task 208; displaying a progression of the crowdfunder-provided funds 209; obtaining a crowdsourcing freelancer-inputted performance of work for each of the at least one task 210; and, displaying a progression of performance of work 211.

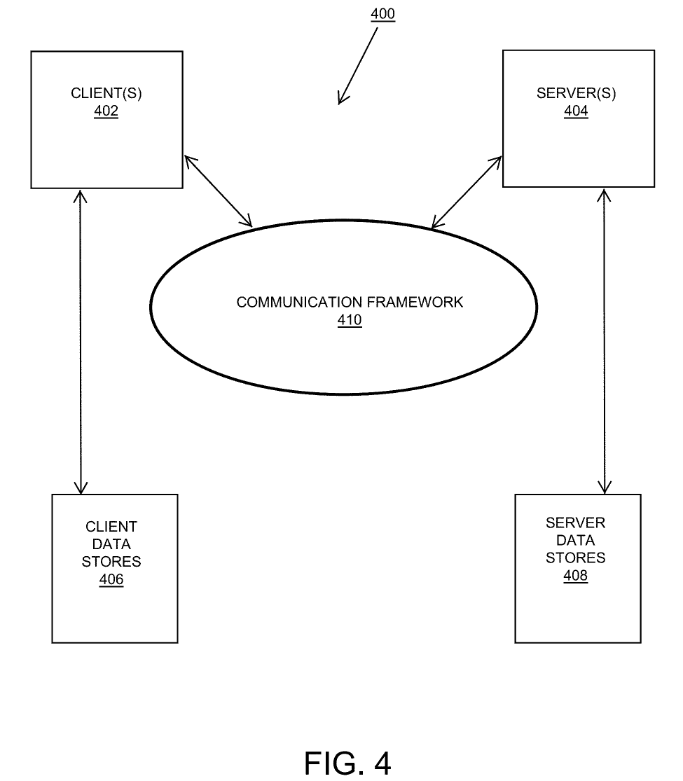

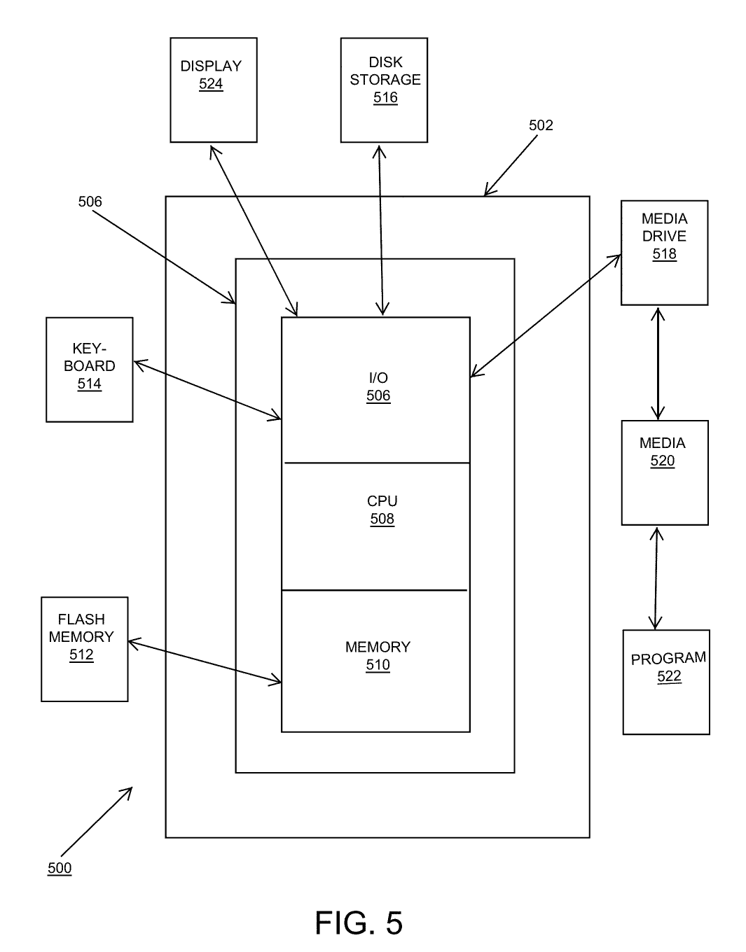

FIGS. 4 and 5 illustrate exemplary computing environments, devices and architectures for the implementation of the various embodiments of the present invention.

FIG. 4 illustrates a sample computing environment 400 that can be utilized in some embodiments. The system 400 further illustrates a system that includes one or more client(s) 402. The client(s) 402 can be hardware and/or software (e.g., threads, processes, computing devices). The system 400 also includes one or more server(s) 404, such as project management tool server 303. The server(s) 404 can also be hardware and/or software (e.g., threads, processes, computing devices). One possible communication between a client 402 and a server 404 may be in the form of a data packet adapted to be transmitted between two or more computer processes. The system 400 includes a communication framework 410 that can be utilized to facilitate communications between the client(s) 402 and the server(s) 404. The client(s) 402 are connected to one or more client data store(s) 406 that can be employed to store information local to the client(s) 402. Similarly, the server(s) 404 are connected to one or more server data store(s) 408 that can be employed to store information local to the server(s) 404.

FIG. 5 depicts an exemplary computing system 500 that can be configured to perform any one of the above-described processes. In this context, computing system 500 may include, for example, a processor, memory, storage, and I/O devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform the above-described processes. The main system 502 includes a motherboard 504 having an I/O section 506, one or more central processing units (CPU) 508, and a memory section 510, which may have a flash memory card 512 related to it. The I/O section 506 is connected to a display 524, a keyboard 514, a disk storage unit 516, and a media drive unit 518. The media drive unit 518 can read/write a computer-readable medium 520, which can contain programs 522 and/or data. Although, not shown, in some embodiments, computing system 500 can include an eye-tracking system and/or be coupled with an eye-tracking system.

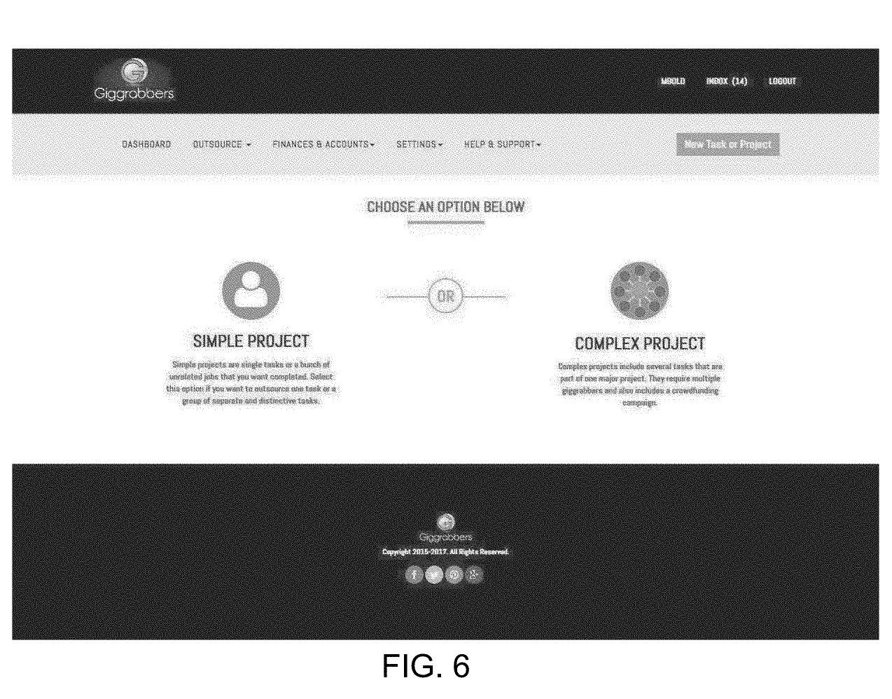

FIGS. 6-19 illustrate screen shots from a graphical user interface for implementations of some of the embodiments of the present invention.

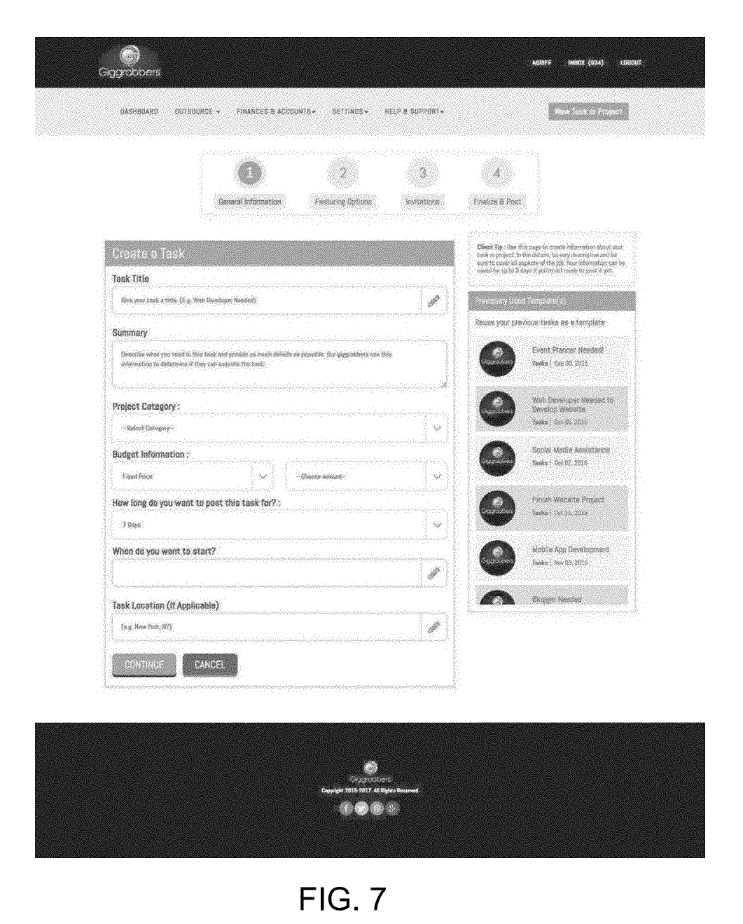

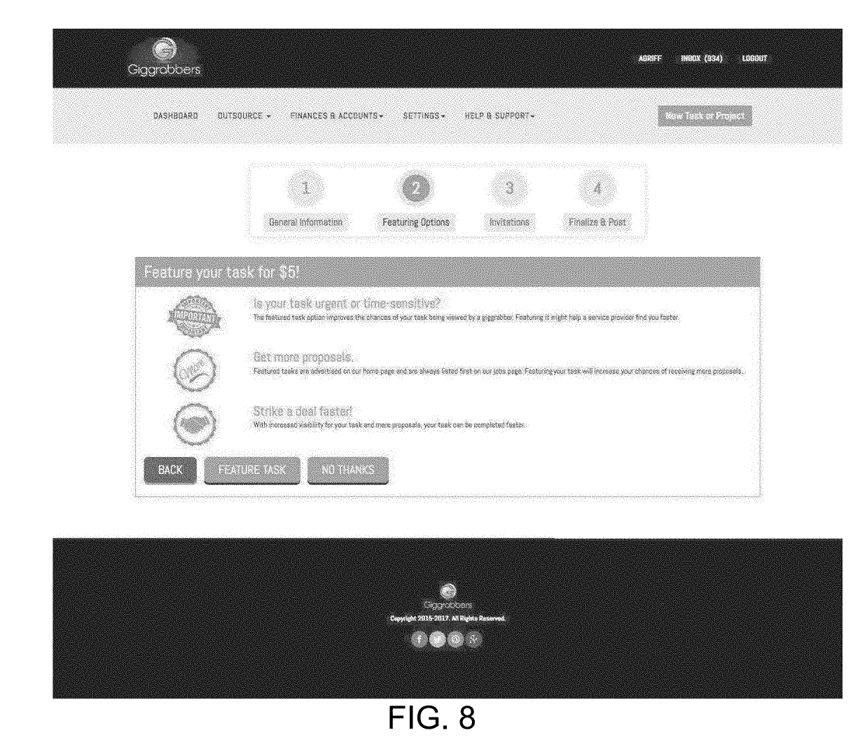

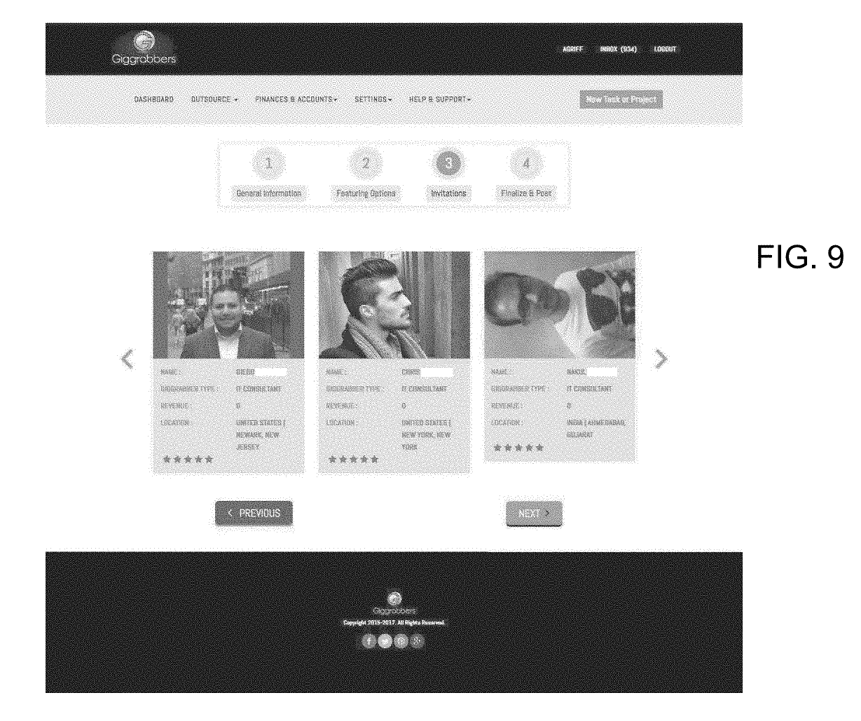

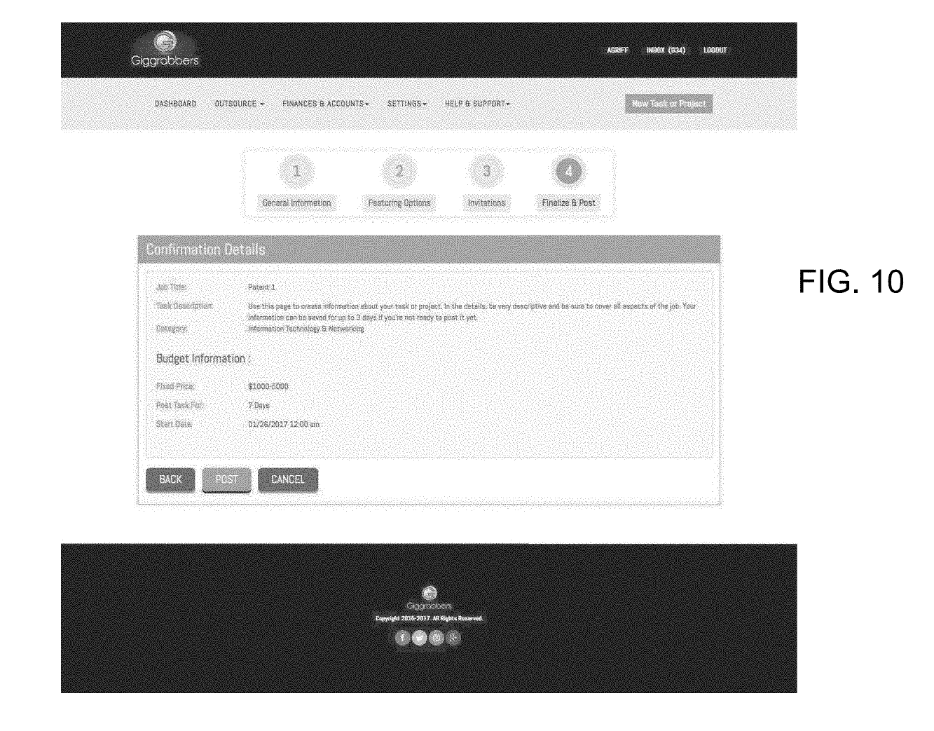

FIG. 6 illustrates the option for a client 150 to choose between a simple project (one task) or a complex project (more than one task). FIG. 7 depicts the “General Information” form that a client 150 would complete to describe a task. The information may contain the task title, summary, project category, budget information, duration of posting of task, the desired start date, the task location, among other information. FIG. 8 illustrates the “Featuring Options” to allow a client 150 to feature a task for a fee (e.g., $5). If a client 150 utilizes this function, then the client 150 may receive more proposals from crowdsourcing freelancers 151 because the client's 150 task will be advertised on the project management tool homepage, for example. FIG. 9 depicts the “Invitations” function, where the client 150 reviews crowdsourcing freelancers 151 that have the relevant experience to work on the task. FIG. 10 illustrates the “Finalize & Post” function. After the client 150 has provided the task information, chosen whether to feature the task, and selected the crowdsourcing freelancers 151 to invite, the client may finalize and post the task, thereby displaying the details of task, featuring the task (if so selected), and inviting the chosen crowdsourcing freelancers 151.

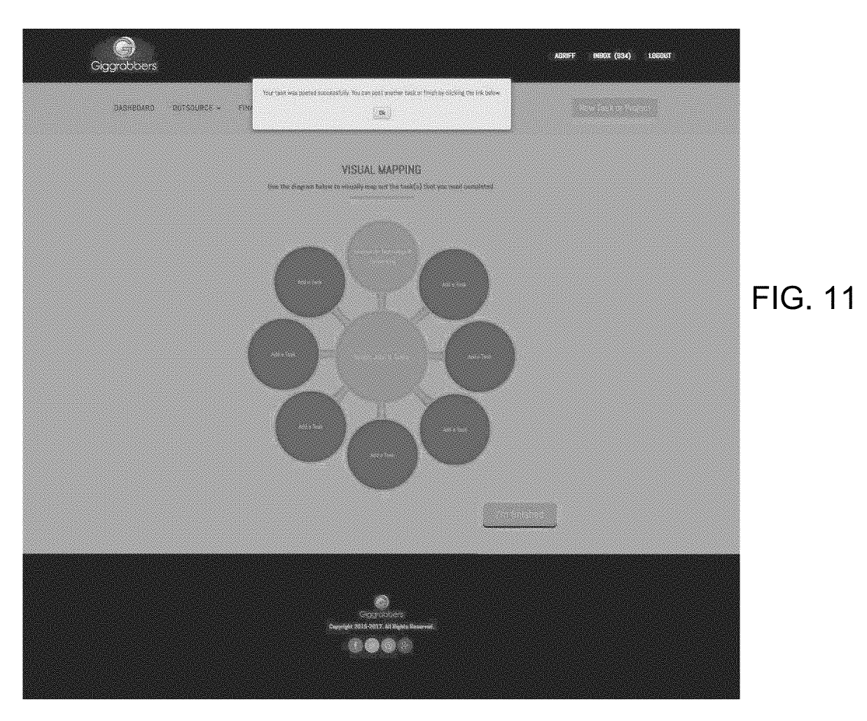

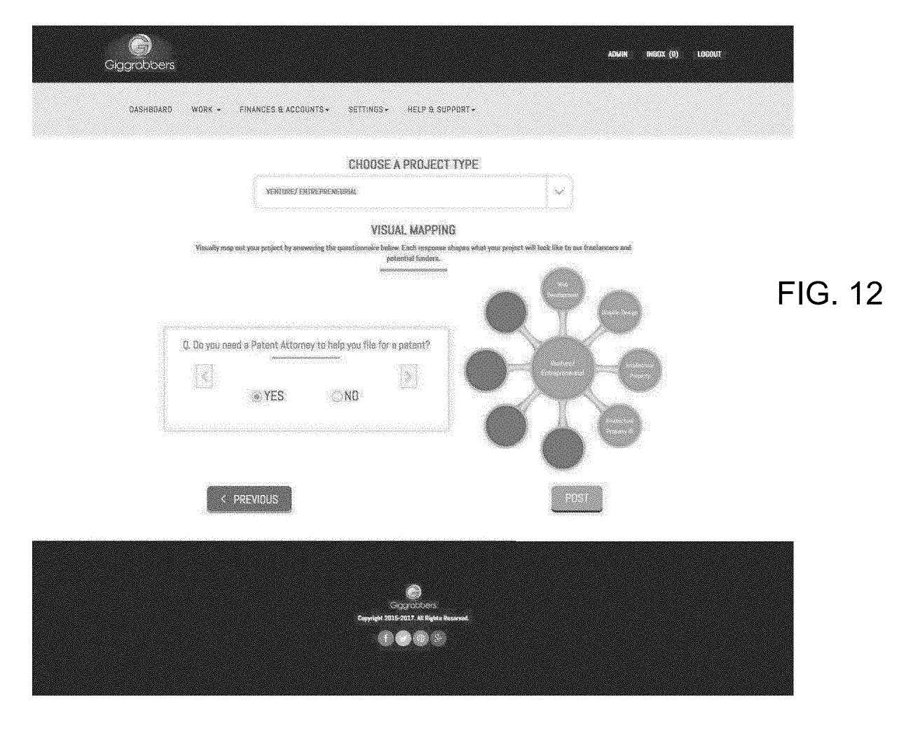

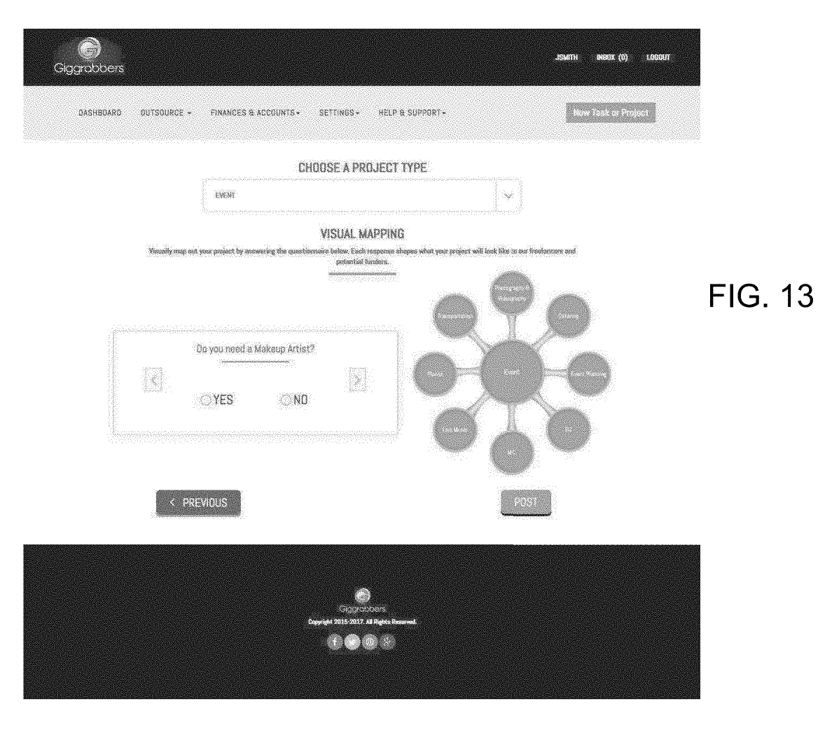

FIGS. 11, 12 and 13 illustrate the “Visual Mapping” of the tasks. FIG. 11 illustrates the visual mapping of a simple project with only one task, whereas FIGS. 12 and 13 illustrate the visual mapping of a complex project with multiple tasks. When a crowdfunder 152 views the Visual Map and selects a task, the crowdfunders 152 will be able to see all the details of the task. This provides transparency, as the crowdfunders 152 will be able to see what exactly what they are funding and how the money will be spent. There is also a level of accountability as the crowdfunders' 152 money will go toward the specific task that they had chosen.

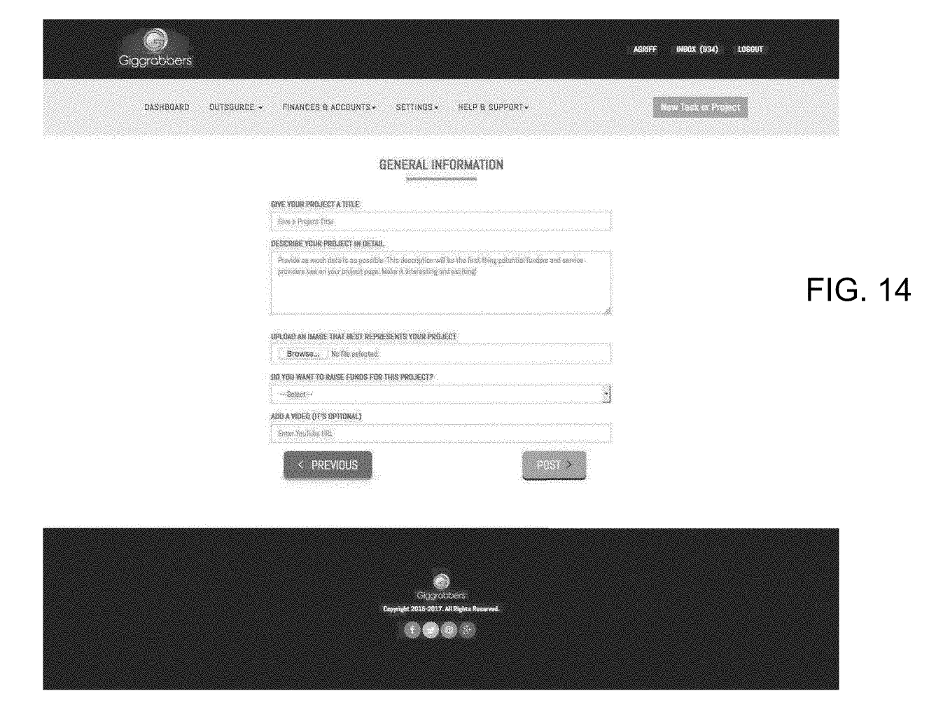

FIG. 14 illustrates an example of the “General Information” page for a project. The client 150 may provide a title and description for a project, upload an image or video, and indicate whether the client 150 wishes to raise funds for the project.

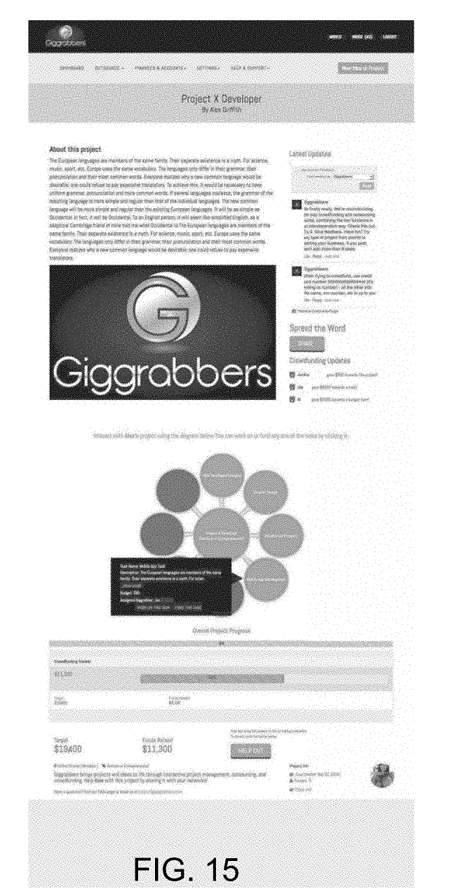

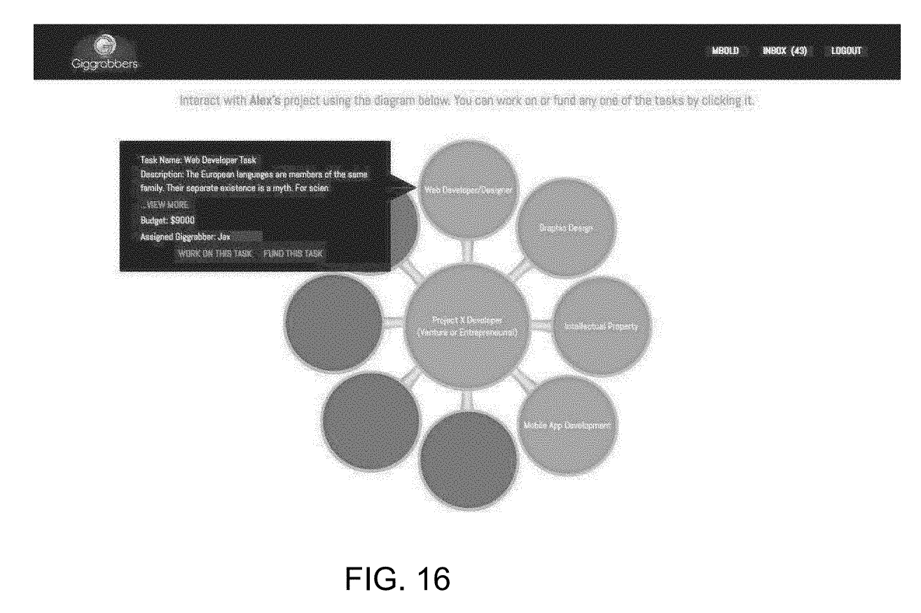

FIG. 15 depicts a page for a crowdfunder 152, where the crowdfunder 152 may read the description of the project, the various tasks of the project, a “Crowdfunding Tracker,” which indicates the amount of funding already received, an option to “Share” the details of the project through social media, and an option to “Help Out” by funding the project. FIG. 16 depicts another page for a crowdfunder 152, who may select a task which results in details of the project being displayed.

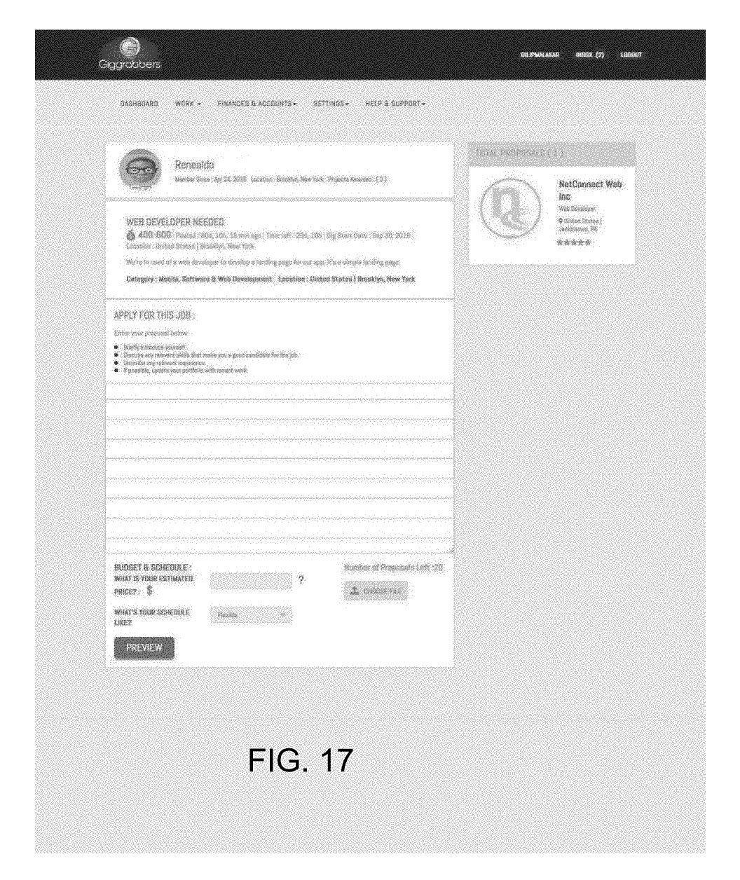

FIG. 17 illustrates a page for a crowdsourcing freelancer 151 to read about a task. The information includes the type of personnel needed, the amount of pay, when the task was posted, amount of time left of the posting, start date, description, category, location, total number of proposals, name of client 150, among other information.

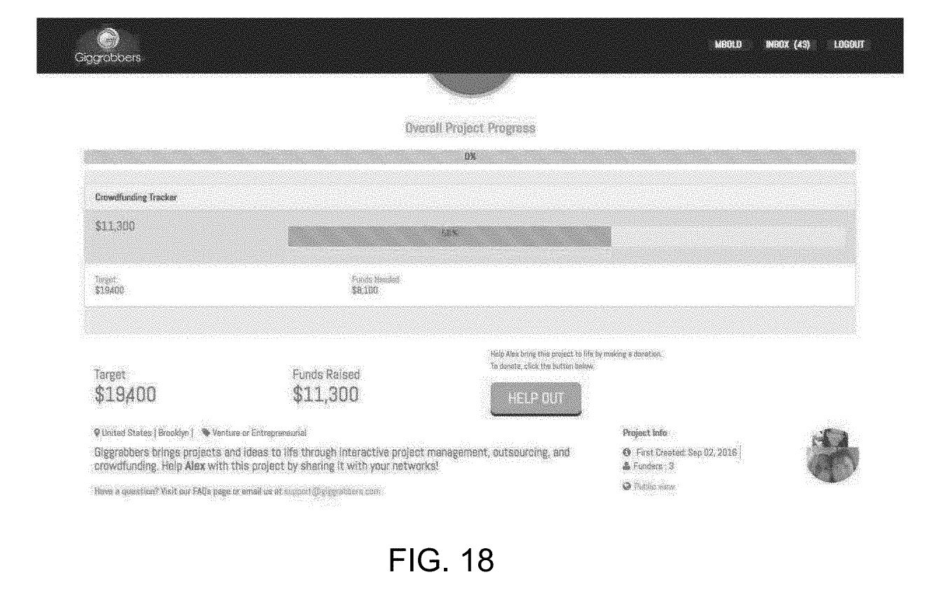

FIG. 18 is another depiction of the “Crowdfund Tracker.”

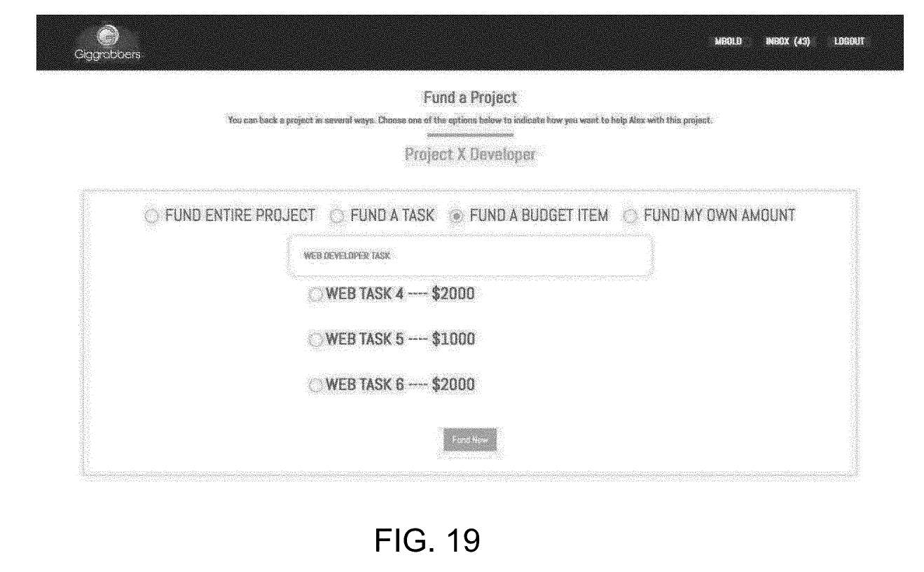

FIG. 19 illustrates a page for a crowdfunder 152, who may fund a project entirely, a task, part of a task (Budget Item), or an amount decided by the crowdfunder 152.

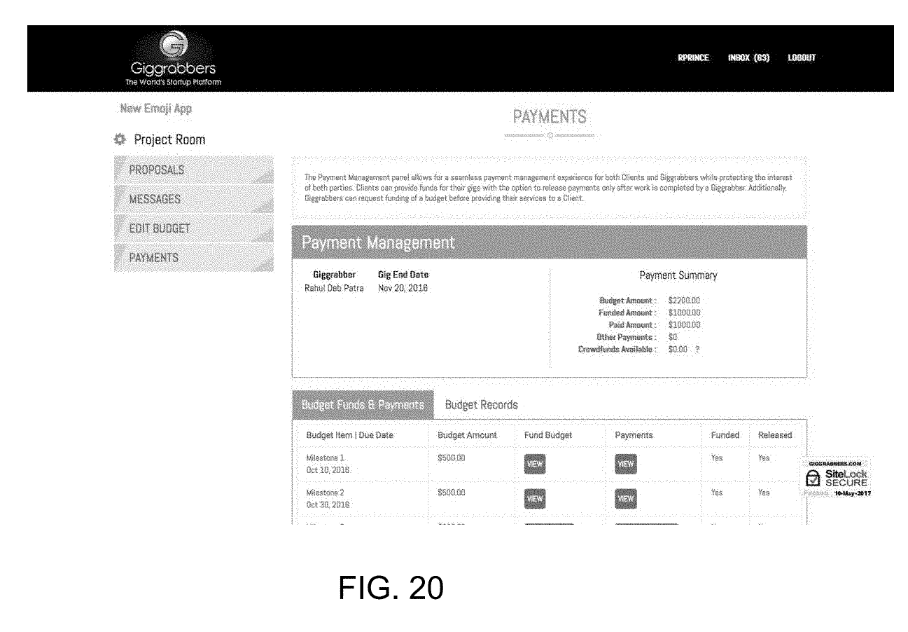

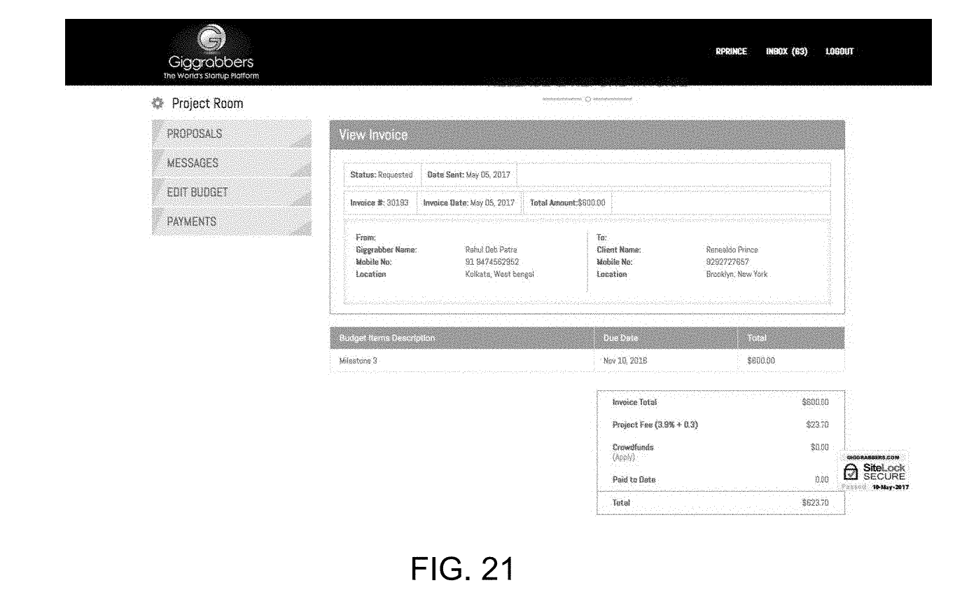

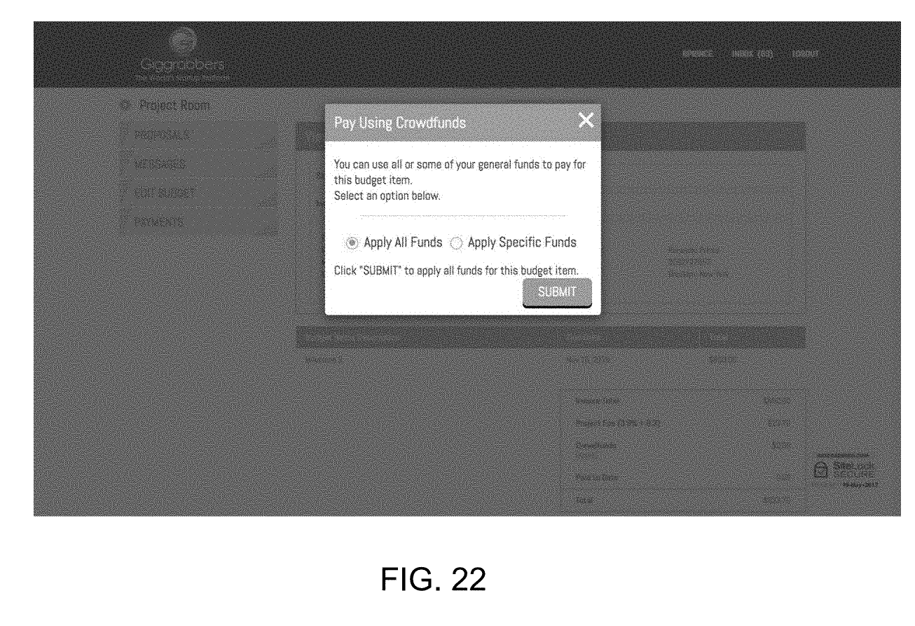

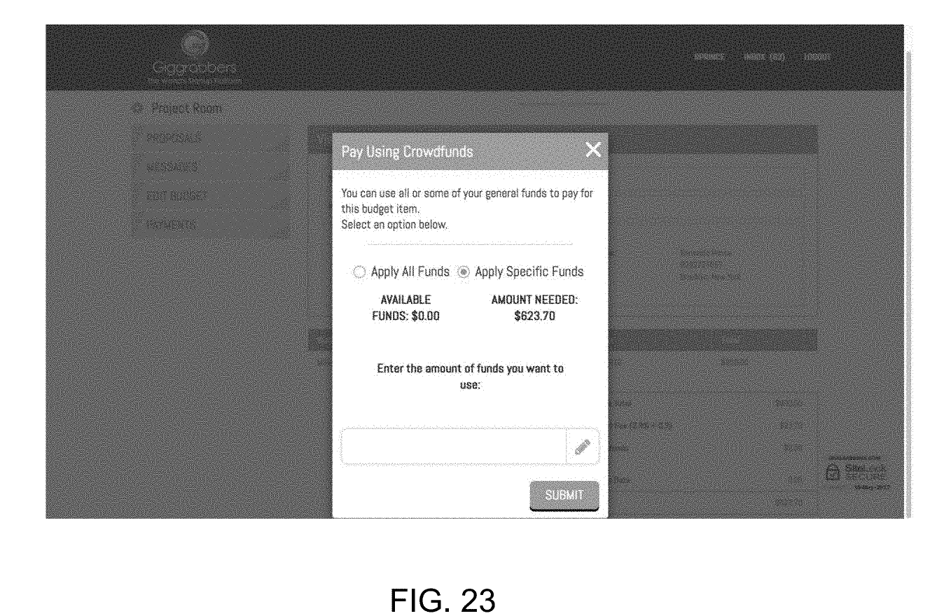

FIGS. 20-23 illustrate pages for a client 150. FIG. 20 shows an example of a payment management page for a particular task and lists information, such as, budget amount, funded amount, paid amount, other payments, and crowdfunding available. If a crowdfunder 152 has specified that the funds be applied to a specific task and the funds have not already been utilized, the amount of those funds would appear as “Crowdfunds Available.” If crowdfunds are available, then the client 150, as shown in FIG. 21, may select “Apply” under “Crowdfunds” to manage these funds. After selecting “Apply,” the client 150 is presented with a pop-up window, as illustrated in FIG. 22, which provides options to either “Apply All Funds” or “Apply Specific Funds.” If the client 150, chooses “Apply Specific Funds” and then submits the selection, the client 150 is presented with another pop up window, as shown in FIG. 23. The client 150 then is able to enter the amount that the client 150 wishes to apply to the task. The “Available Funds” relate to funds from crowdfunders 152, where the crowdfunders 152 had specified that their funds are to be restricted to a particular task. The references to “general funds” in FIGS. 22 and 23 are for funds where the crowdfunder had not specified a task for their funds.

I claim:

1. A computer system comprising:
at least one processor unit;
at least one memory unit coupled to the at least one processor unit; and,
computer readable instructions embodied in the memory unit and executable by the processor unit, wherein execution of the instructions by the processor unit causes the computing system to perform a method of managing a project of a client, the method comprising:
receiving a client-created project, wherein the project comprises at least one task;
and, wherein each of the at least one task comprises an associated cost;
displaying the associated costs for each of the at least one task;
displaying a graphical user interface of each of the at least one task of the project;
obtaining a client-indicated invitation for a crowdsourcing freelancer for each of the at least one task;
receiving a crowdsourcing freelancer-submitted proposal;
receiving a client-awarded crowdsourcing freelancer job;
obtaining a client-proposed request for funding for each of the at least one task;
receiving a crowdfunder-provided funds for a crowdfunder specified task;
displaying a progression of the crowdfunder-provided funds;
obtaining a crowdsourcing freelancer-inputted performance of work for each of the at least one task; and,
displaying a progression of performance of work.

2. The computer system of claim 1, wherein the crowdfunder funds the at least one task.

3. The computer system of claim 2, wherein the crowdfunder is the client.

4. The computer system of claim 1, wherein the crowdfunder funds the project.

5. The computer system of claim 4, wherein the crowdfunder is the client.

6. The computer system of claim 1, wherein the crowdfunder funds a part of the at least one task.

7. The computer system of claim 6, wherein the crowdfunder is the client.

8. A method of managing a project of a client, the method comprising:
receiving a client-created project, wherein the project comprises at least one task; and,
wherein each of the at least one task comprises an associated cost;
displaying the associated costs for each of the at least one task;
displaying a graphical user interface of each of the at least one task of the project;
obtaining a client-indicated invitation for a crowdsourcing freelancer for each of the at least one task;
receiving a crowdsourcing freelancer-submitted proposal;
receiving a client-awarded crowdsourcing freelancer job;
obtaining a client-proposed request for funding for each of the at least one task;
receiving a crowdfunder-provided funds for a crowdfunder specified task;
displaying a progression of the crowdfunder-provided funds;
obtaining a crowdsourcing freelancer-inputted performance of work for each of the at least one task; and,
displaying a progression of performance of work.

9. The method of managing a project of a client of claim 8, wherein the crowdfunder funds the at least one task.

10. The computer system of claim 9, wherein the crowdfunder is the client.

11. The method of managing a project of a client of claim 8, wherein the crowdfunder funds the project.

12. The computer system of claim 11, wherein the crowdfunder is the client.

13. The method of managing a project of a client of claim 8, wherein the crowdfunder funds a part of the at least one task.

14. The computer system of claim 13, wherein the crowdfunder is the client.

15. A non-transitory computer readable medium having computer readable instructions embodied therein, the computer readable instructions being configured to implement a method of managing a project of a client when executed, the method comprising:
receiving a client-created project, wherein the project comprises at least one task; and,
wherein each of the at least one task comprises an associated cost;
displaying the associated costs for each of the at least one task;
displaying a graphical user interface of each of the at least one task of the project;
obtaining a client-indicated invitation for a crowdsourcing freelancer for each of the at least one task;
receiving a crowdsourcing freelancer-submitted proposal;
receiving a client-awarded crowdsourcing freelancer job;
obtaining a client-proposed request for funding for each of the at least one task;
receiving a crowdfunder-provided funds for a crowdfunder specified task;
displaying a progression of the crowdfunder-provided funds;
obtaining a crowdsourcing freelancer-inputted performance of work for each of the at least one task; and,
displaying a progression of performance of work.
